(19) United States
(12) Patent Application Publication
(10) Pub. No.: US 2011/0002239 A1
(43) Pub. Date: Jan. 6, 2011

(54) Determining the Location of a Femtocell

(76) Inventor: Muthaiah Venkatachalam, Beaverton, OR (US)

Correspondence Address: TROP, PRUNER & HU, P.C., 1616 S. VOSS RD., SUITE 750, HOUSTON, TX, 77057-2631, US

(21) Appl. No.: 12/645,575

(22) Filed: Dec. 23, 2009

Related U.S. Application Data
(60) Provisional application No. 61/223,360, filed on Jul. 6, 2009.

(51) Int. Cl. H04L 12/28; H04W 4/02

(52) U.S. Cl. 370/254; 370/338

(57) ABSTRACT

A server may automatically attempt to locate a femtocell. Information may be obtained from the femtocell or neighboring femtocells to determine location. Servers associated with the femtocell may be contacted using that information to determine the femtocells location.

### CROSS-REFERENCE TO RELATED APPLICATIONS

This application claims priority to provisional application 61/223,360, filed Jul. 6, 2009 and that provisional application is incorporated by reference herein.

### BACKGROUND

This relates generally to wireless networks and, particularly, to wireless networks using WiMAX technology.

In wireless networks, including those compliant with the WiMAX standard, a femtocell may be utilized. Generally, a femtocell is a cell contained within a user's home. The user may use the femtocell to connect a variety of devices using short range wireless technology. Then the femtocell is linked through a broadband access network, such as a cable or DSL network to a server.

Generally, a femtocell may be set up by a user, to some degree, independently of a network operator or service provider. For example, the broadband service provider has no idea that the signals that it is receiving are fed through a femtocell. It simply knows there is a connection for broadband access.

### BRIEF DESCRIPTION OF THE DRAWINGS

FIG. 1 is an architecture depiction of one embodiment;

FIG. 2 is a sequence chart for one embodiment; and

FIG. 3 is a flow chart for one embodiment.

### DETAILED DESCRIPTION

A femtocell may be a small wireless cell using a low power, short range connection within a user's home. For example, the connection may be by Bluetooth short range wireless link. The connection links to a gateway which, in turn, couples to a broadband network, such as a cable or digital subscriber link (DSL) network. Within the femtocell, an access point serves as the contact point for all of the stations within the femtocell. These stations, for example, may be a laptop computer, a printer, or a cell phone, to mention some examples.

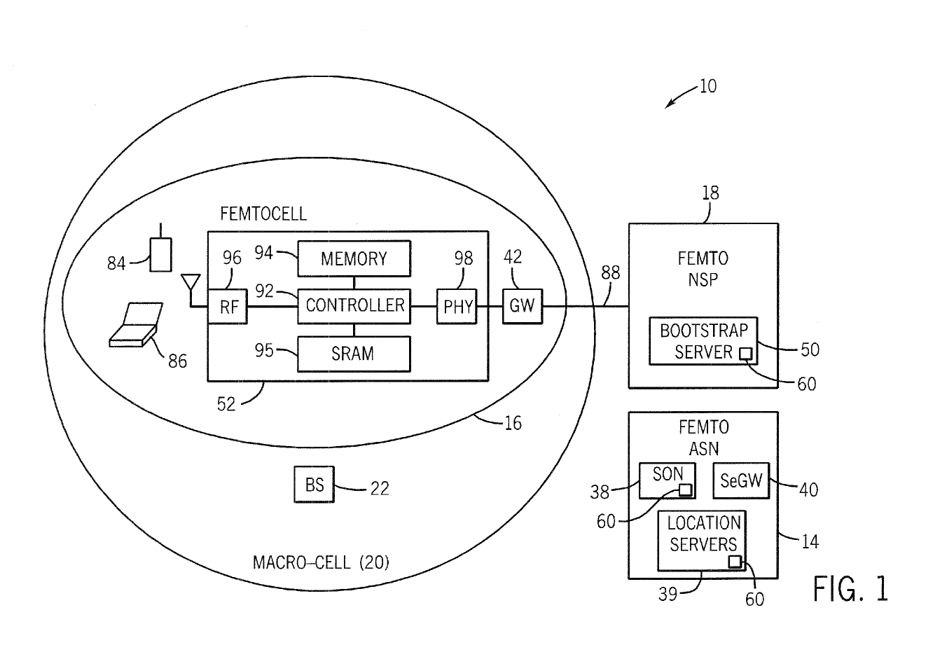

Referring to FIG. 1, a wireless network 10 may include a femtocell 16 within a user's home. Various items may communicate within the femtocell, such as a cell phone 84 or a laptop computer 86, using a short range wireless protocol. The femtocell may also communicate with a home or femto gateway (GW) 42, adapted to operate with a DSL or cable connection 88. The femtocell 16 may be part of a macro-cell 20, including a base station 22.

The connection 42 connects the femtocell 16 to a mobile network service provider's (NSP's) network 18. A bootstrap server 50 initializes the femtocell on the operator's network.

The femtocell access point 52 may include a controller 92 coupled to a non-volatile memory 94. A volatile memory 95 may be a static random access memory (SRAM) in one embodiment. A radio frequency transceiver 96 may provide wireless signals for proximate devices. The memory 94 may be a flash memory in one embodiment. An Ethernet physical layer 98 connects the controller 92 to the femto gateway 42.

In a software implemented embodiment, the memory 94 may store instructions executed by the controller 92. However, other storage/controller combinations may also be used.

A femto access service network (ASN) 14 may include a Self Organization Network (SON) server 38 and a security gateway (SeGW) 40. Location servers 39 on the ASN 14 may be used for global positioning.

The femtocell may be initiated by the user without network involvement. The signals from the femtocell nodes and access point may be fed over the broadband service network without knowledge of the existence of the femtocell by any service provider. Thus, the location of the femtocell in a WiMAX (IEEE Std. 802.16-2004, IEEE Standard for Local and Metropolitan Area Networks, Part 16: Interface for Fixed Broadband Wireless Access Systems, IEEE New York, N.Y. 10016) or WiFi (IEEE Std. 802.11 (1999-07-015) Wireless LAN Medium Access Control (MAC) and Physical Layer Specifications) network is initially unknown. It is desired to locate the femtocell in order to locate the correct security gateway for the femtocell to connect to.

It is also desirable to know the location of the cell to authorize the femtocell in the network before the femtocell can begin its radio frequency transmissions. This is a regulatory requirement in the United States and many other countries. The location of mobile stations attached to the femtocells also needs to be identified in the operator's network 18. The location of these mobile devices is needed for location based services and emergency calling for users in a femtocell deployment. For example, the user of a cell phone in a femtocell may assume that emergency services are provided. But when the connection is made over the short range wireless connection and through the broadband connection, the emergency services would not be readily accessible.

Thus, to summarize, there are at least two scenarios in which the location of the femtocell or its constituents may be needed. The location of the femtocell is needed to locate the correct security gateway (SeGW) 40 for the femtocell to connect to during the initialization of the femtocell. This information needs to be provided to a bootstrap server 50 that bootstraps the initialization of the femtocell. In addition, the location of the femtocell on the network is needed before the femtocell can begin radio frequency transmissions for regulatory reasons.

For the first scenario, an access point in the femtocell may provides its Internet Protocol address to a bootstrap server 50. The bootstrap server can then do a rough location calculation based on the Internet Protocol address and provide the address for the security gateway 40 with the Internet Protocol address to which the femtocell can connect.

The access point may provide information to the Self-Organization Network (SON) server 38, including its public Internet Protocol address. Then the SON server can use the public Internet Protocol (IP) address to contact the backhaul service provider, such as the cable or DSL provider for the civic location information. The civic location is the subscriber's street name or locality.

In addition, it may be possible to get global positioning system (GPS) information if available on the access point and coverage is available. Often global positioning system information does not work indoors and femtocells are often deployed indoors. However, if the global positioning system information is available, the SON server can accurately locate the femtocell to the order of tens of meters.

In addition, a neighbor WiMAX macro-cell and/or femtocell base station may be determined by an access point scanning procedure, such as base station identifier (BSID), received signal strength indicator (RSSI), and the relative delay of two nearby base stations. If the BSID of a neighbor femtocell is provided by the current femtocell, this means that the SON server has authorized the transmission of the neighbor femtocell and, hence, the SON server knows the location of the neighbor femtocell. The SON server can use this as the approximate location of the current femtocell as well. Then the SON server can talk to the WiMAX location server to determine the location of the femtocell when the femtocell provides the neighbor WiMAX macro-cell information, such as BSID, RSSI, and relative delay.

If WiFi/3G/2G information is present on the access point and there is coverage, the WiFi information may provide useful location information, for example, via LOKI, available from Skyhook Wireless, Inc., Boston, Mass. 02210, USA. The SON server needs to talk to the location servers of these other technologies.

If nothing else works, then it may be necessary to manually intervene. This may be triggered by the SON server to the physical operations center. The user may be asked to provide and verify his or her current civic location, such as a zip code, street address, etc. via web interface or phone call.

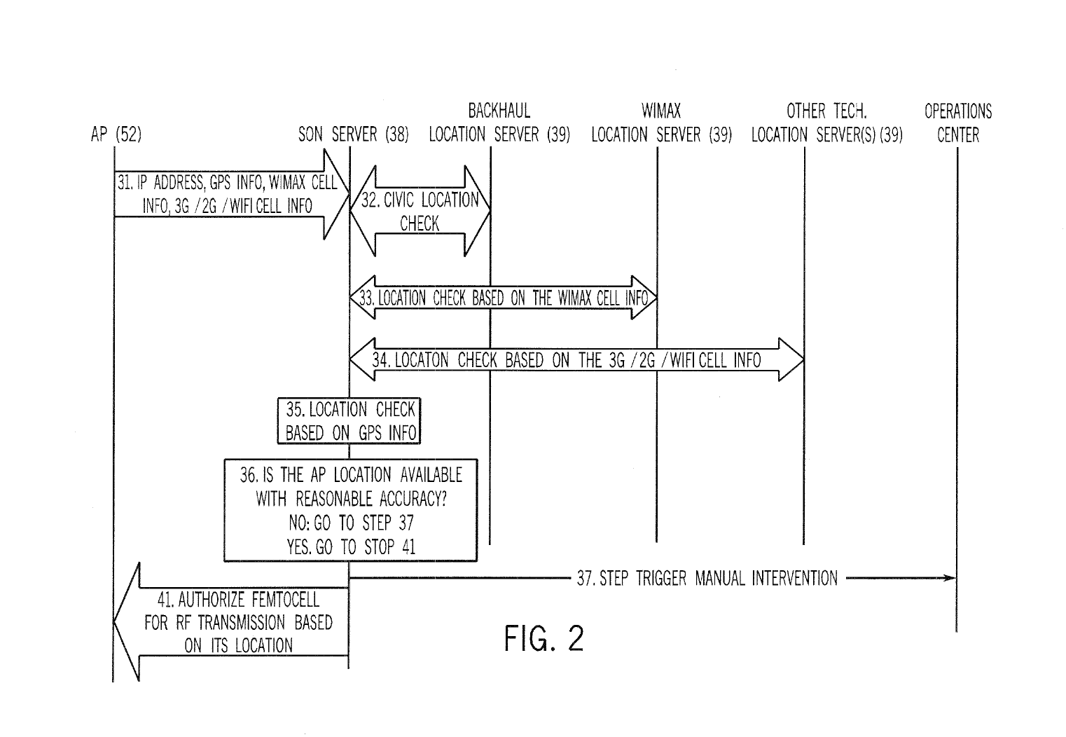

Thus, referring to FIG. 2, at 31, the IP address information, GPS information, WiMAX cell information, or 3G/2G WiFi cell information, as available may be forwarded by an access point to the SON server. Then, at 32, the SON server can implement a civic location check with the backhaul location server. At 33, a location check may be implemented based on the WiMAX cell information between the SON server and the WiMAX location server. At 34, a location check may be based on the 3G/2G/WiFi cell information between the SON server and other technical location servers 39.

At 35, a location check is done based on GPS information. At 36, a check determines if the access point location is available with reasonable accuracy. If not, then the flow proceeds to step 37. Otherwise, the flow proceeds to step 41. At step 41, the SON server authorizes a femtocell for RF transmission based on its location. At 37, manual intervention is triggered.

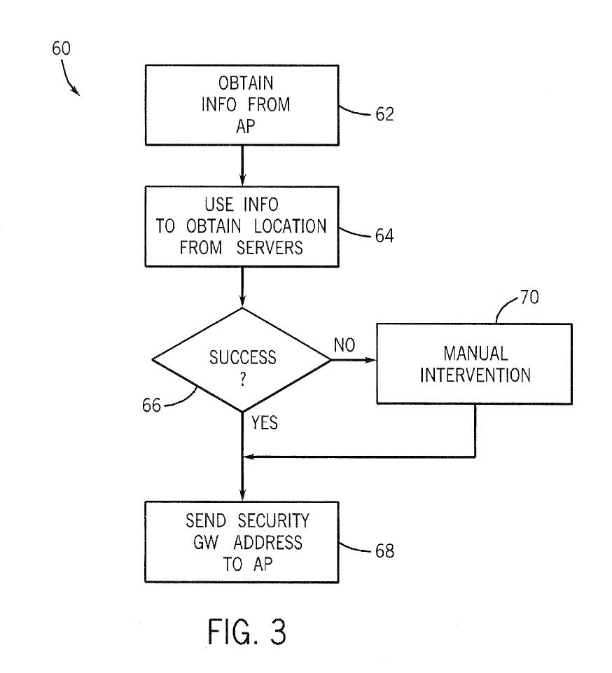

Referring to FIG. 3, the sequence 60 may be implemented in software, hardware, or firmware. In a software embodiment, it may implemented by a computer readable medium storing instructions executed by a controller. The computer readable medium may be any semiconductor, optical, or magnetic storage medium. The instructions to implement the sequence 60 may be stored on one or more of the SON server 38, the backhaul server 39, and the location server 39, in one embodiment.

Initially, information to devine the location of the femtocell is obtained from a femtocell access point, as indicated in block 62. The information is used to obtain location information from servers for that femtocell, as indicated in block 64. If this information proves to be successful, as determined in diamond 66, the security gateway address so obtained is sent to the access point in block 68. Otherwise, in block 70, manual intervention is tried.

Since the femtocell is expected to be small or at close range, the simplest approximation for the location of a user in a femtocell is the location of the femtocell itself. Further enhancements can be made based on GPS or WiMAX signal strength measurements as needed.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
querying an access point of a femtocell for information from which location information may be derived; and
automatically attempting to locate the femtocell in a wireless network.

2. The method of claim 1 wherein automatically attempting to locate includes contacting a backhaul server to obtain the civic location of the femtocell.

3. The method of claim 1 wherein automatically attempting to locate includes obtaining WiMAX cell information from a WiMAX location server.

4. The method of claim 1 wherein automatically attempting to locate includes doing a location check based on 3G/2G/WiFi cell information.

5. The method of claim 1 wherein automatically attempting to locate includes using global positioning system information.

6. The method of claim 1 wherein automatically attempting to locate includes obtaining information about the location of a neighboring femtocell.

7. The method of claim 1 including determining if automatic femtocell location is possible and, if not, manually obtaining the location information.

8. A computer readable medium storing instructions executed by a computer to:
query an access point of a femtocell for information from which location information may be derived; and
automatically attempt to locate the femtocell in a wireless network.

9. The medium of claim 8 further storing instructions to contact a backhaul server to obtain the civic location of the femtocell.

10. The medium of claim 8 further storing instructions to obtain WiMAX cell information from a WiMAX location server.

11. The medium of claim 8 further storing instructions to use global positioning system information to locate the femtocell.

12. The medium of claim 8 further storing instructions to obtain information about the location of a neighboring femtocell to locate the femtocell in a wireless network.

13. An apparatus comprising:
a server; and
a storage coupled to said server, said server storing instructions to automatically locate a femtocell in a wireless network.

14. The apparatus of claim 13 wherein said server is a bootstrap server.

15. The apparatus of claim 13 wherein said server is a self-organization network server.

16. The apparatus of claim 13 wherein said server is a location server.
